(19) United States
(12) Patent Application Publication
(10) Pub. No.: US 2015/0356167 A1
(43) Pub. Date: Dec. 10, 2015

(54) Generating a social circle for a user

(71) Applicants: Lijiang CHEN, (US); Shimin CHEN, (US); HEWLETT-PACKARD DEVELOPMENT COMPANY, L.P., Houston, TX (US)

(72) Inventors: Lijiang Chen, Beijing (CN); Shimin Chen, Beijing (CN)

(21) Appl. No.: 14/759,966

(22) PCT Filed: Feb. 27, 2013
(86) PCT No.: PCT/CN2013/071934

§ 371 Date: Jul. 9, 2015

(51) Int. Cl. G06F 17/30

(52) U.S. Cl. CPC G06F 17/30604; G06F 17/30598; G06F 17/30876; G06F 17/30958; G06Q 50/01

(57) ABSTRACT

A technique for generating a social circle for a user of a social network is provided. A personalized circle-user graph (PCUG) model may be constructed based on friends of the user and social circles joined by the friends. At least partly based on connections between the friends and social circles in the PCUG model, the social circles may be ranked. A candidate social circle may be generated based on rankings of the social circles.

### BACKGROUND

Social media platforms such as twitter, Facebook, Google plus, Sina weibo, etc. are becoming more important in online business. They are not only platforms for communicating but also places for product selling, advertising and consumer study. A social circle is one feature of social media platforms. Examples of social circles include twitter lists, friend lists in Facebook, circles in Google plus, and groups in Sina weibo.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a block diagram of a system that may generate a social circle for a user of a social network according to an example of the present disclosure;

FIG. 2 is a schematic diagram of a personalized circle-user graph (PCUG) model for users and social circles they join according to an example of the present disclosure;

FIG. 3 is a process flow diagram for a method of generating a social circle for a user of a social network according to an example of the present disclosure;

FIG. 4 is a process flow diagram for another method of generating a social circle for a user of a social network according to another example of the present disclosure;

FIG. 5 is a process flow diagram for a method of merging social circles based on similarity of their names according to an example of the present disclosure;

FIG. 6 is a process flow diagram for another method of generating a social circle for a user of a social network according to another example of the present disclosure;

FIG. 7 is a process flow diagram for another method of generating a social circle for a user of a social network according to another example of the present disclosure;

FIG. 8 is a block diagram showing a non-transitory, computer-readable medium that stores code for generating a social circle for a user of a social network according to an example of the present disclosure.

### DETAILED DESCRIPTION

Systems and methods for generating a social circle for a user of a social network are disclosed. A user may exist in a social circle for various reasons, such as sharing a common interest with other members in the social circle, being related to the creator of the social circle in a way (e.g. as a family member, friend, neighbor, or colleague), and etc. An example of the systems and methods disclosed herein takes advantages of relationships between a target user's friends and the social circles these friends join to generate a candidate social circle that can be recommended to the target user. Another example disclosed herein can further take into account the similarity between contents posted by the friends when generating a candidate social circle for the target user.

In the following, certain examples according to the present disclosure are described in detail with reference to the drawings.

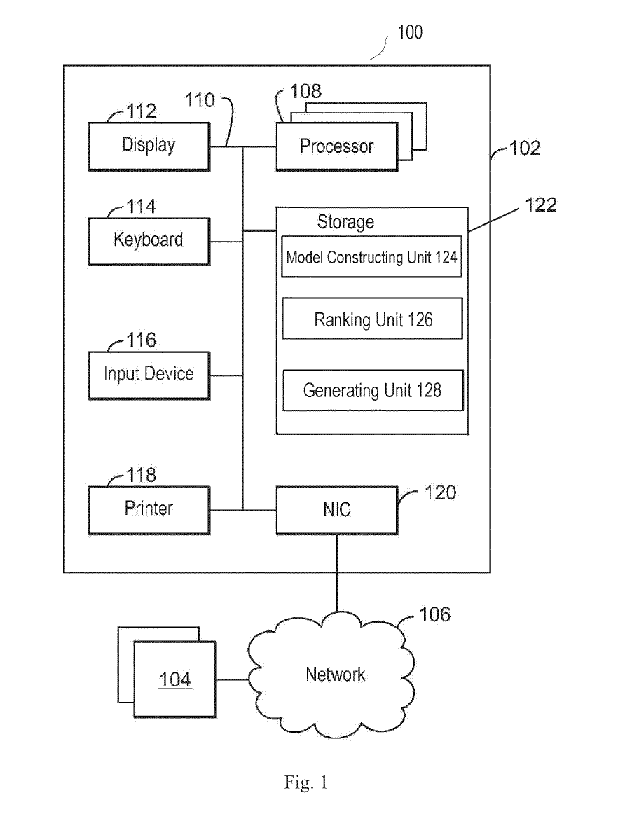

FIG. 1 is a block diagram of a system that may generate a social circle for a user of a social network according to an example of the present disclosure. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are but one example of functional blocks and devices that may be implemented in an example. Those of ordinary skill in the art would readily be able to define specific functional blocks based on design considerations for a particular electronic device.

The system 100 may include a server 102, and one or more client computers 104, in communication over a network 106. As illustrated in FIG. 1, the server 102 may include one or more processors 108 which may be connected through a bus 110 to a display 112, a keyboard 114, one or more input devices 116, and an output device, such as a printer 118. The input devices 116 may include devices such as a mouse or touch screen. The processors 108 may include a single core, multiple cores, or a cluster of cores in a cloud computing architecture. The server 102 may also be connected through the bus 110 to a network interface card (NIC) 120. The NIC 120 may connect the server 102 to the network 106.

The network 106 may be a local area network (LAN), a wide area network (WAN), or another network configuration. The network 106 may include routers, switches, modems, or any other kind of interface device used for interconnection. The network 106 may connect to several client computers 104. Through the network 106, several client computers 104 may connect to the server 102. The client computers 104 may be similarly structured as the server 102.

The server 102 may have other units operatively coupled to the processor 108 through the bus 110. These units may include tangible, machine-readable storage media, such as storage 122. The storage 122 may include any combinations of hard drives, read-only memory (ROM), random access memory (RAM), RAM drives, flash drives, optical drives, cache memory, and the like. Storage 122 may include a model constructing unit 124, a ranking unit 126 and a generating unit 128. Storage 122 may be referred to as a memory device.

The model constructing unit 124 may construct a personalized circle-user graph (PCUG) model based on friends of a user in a social network and social circles joined by these friends. In a social network, while creating a social circle, the creator put members into that circle. It can be any reason that a user is added as a member of a particular social circle. The behavior of placing a user in a social circle can be viewed as a tagging action for the user. Users with similar tags (i.e., being members of the same social circle) may share some common features. Moreover, users being put into the same social circle may have something in common according to the creator's point of view. The PCUG model disclosed herein is built from the existing social circle structures and relationship between users and social circles.

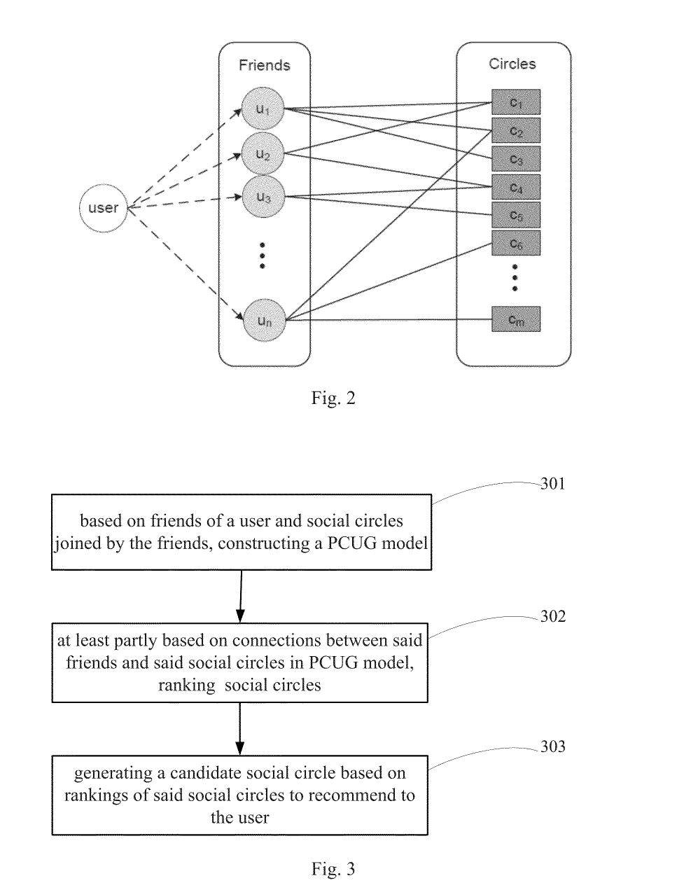

FIG. 2 illustrates a schematic diagram of a PCUG model according to an example of the present disclosure. In the PCUG model shown in FIG. 2, the node on the left side represents a target user for which a social circle is to be generated, the user nodes u₁ to uₙ in the middle represent friends of the target user, and the circle nodes c₁ to cₘ on the right side represent social circles respectively joined by the friends u₁ to uₙ, wherein if a friend of the target user joins a social circle, there exists a connection (i.e. an edge) that connects the user node to the social circle node. Users u₁ to uₙ are co-occurred if they have edges to the same social circle. It is possible that two users can co-occur in more than one social circle. The PCUG model described herein can be constructed based on the existing social circles created by any of the target user's friends. For each friend of the target user, the social circles joined by this friend can be incorporated and connections between this friend and these social circles can be added. If a friend's social circle already exists, then there is no need to add the social circle and instead only a connection will be added between the friend and the social circle. As a result, an undirected bipartite graph as shown in FIG. 2 will be created. Please be noted that this graph can be stored in any suitable data structure.

The ranking unit 126 may rank the social circles in the PCUG model at least partly based on connections between the users and the social circles. The generating unit 128 may generate a candidate social circle based on rankings of said social circles.

With reference to FIG. 3 now, FIG. 3 is a process flow diagram for a method of generating a social circle for a user of a social network according to an example of the present disclosure. At block 301, a personalized circle-user graph (PCUG) model is constructed based on friends of the user and social circles joined by the friends. An example of a PCUG model is shown in FIG. 2 and has been described above. At block 302, the social circles in the PCUG model are ranked at least partly based on connections between the friends and the social circles. According to an example, the rankings of users (i.e. friends of the target user) and social circles are computed iteratively using the following formula (1) and (2), until the ranking values of all users and lists are stable.

$$\begin{matrix}{R}_{u} = {\sum }_{u ∈ c c ∈ {C}_{u}} \frac{{R}_{c}}{\vert c \vert} & ( 1 ) \\ {R}_{c} = {\sum }_{u ∈ c} \frac{{R}_{u}}{\vert {C}_{u} \vert} & ( 2 )\end{matrix}$$

Where |c| is the number of members of social circle c and |Cu| is the social circles user u is in. Given a target user uᵢ, the initial value of Rc is

$${R}_{c}^{0} = {\sum }_{u ∈ {u}_{i}^{f}} circle ( u , c ) ,$$

wherein uᵢ^{f} is the friend set of user uᵢ. The definition of the function circle (u,c) is:

$$circle ( u , c ) = \{ \begin{matrix}0 , & u ∉ c \\ 1 , & u ∈ c\end{matrix} \qquad ( 3 )$$

At block 303, a candidate social circle is generated based on rankings of said social circles. The candidate social circle can be recommended to the user, used for advertising purposes, and etc. For example, after the iterative computation converges, the top-k ranked social circles will be selected as the candidates to be e.g. recommended to the user.

According to another example of the present disclosure, ranking may further comprise ranking social circles based on similarity between contents posted by the friends; combining a rank obtained from content similarity and a rank obtained from said PCUG model to obtain a combined rank; and ranking social circles based on the combined ranks

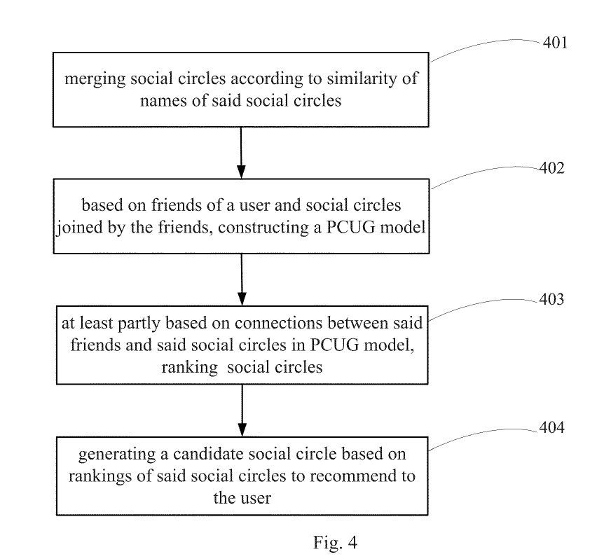

With reference to FIG. 4 now, FIG. 4 is a process flow diagram for another method of generating a social circle for a user of a social network according to another example of the present disclosure. As shown, the method in FIG. 4 is almost the same as method in FIG. 3, except that FIG. 3 further includes a block 401. Blocks 402-404 are the same as blocks 301-303 and will not be described in detail herein. At block 401, before constructing the PCUG model, the method further comprises merging social circles according to similarity of names of the social circles.

A user may name his or her created social circles in various ways. For example, a twitter user may create a circle (or list in twitter's terminology) with his friends that like playing basketball and name this circle as “football”. Similar to most tagging systems, user generated names of social circles may be arbitrary, obscure and difficult to understand. Thus, it can be difficult to identify similar circles using their names. For example, “celeb” and “celebrity” as well as “entertainment” and “entertnmnt” have the same meanings but differ in appearance. In addition, the PCUG model described above may be highly unbalanced due to skewness of co-ocurring relations (a small fraction of users are added in a huge number of social circles, while most users are added in a small number of social circles). To better construct the personalized circle-user graph (PCUG) model and make use of the similarity, social circles can be merged according to similarity of their names.

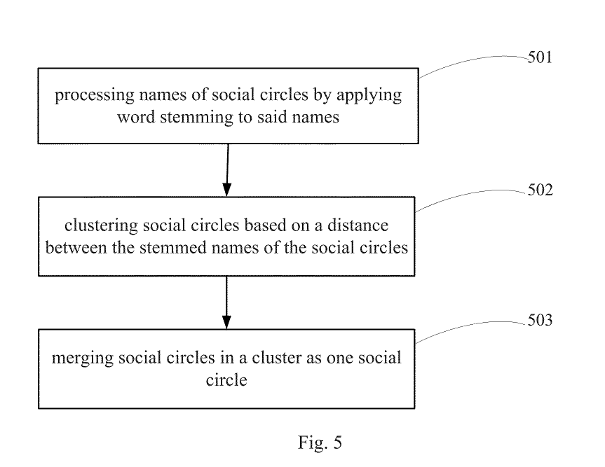

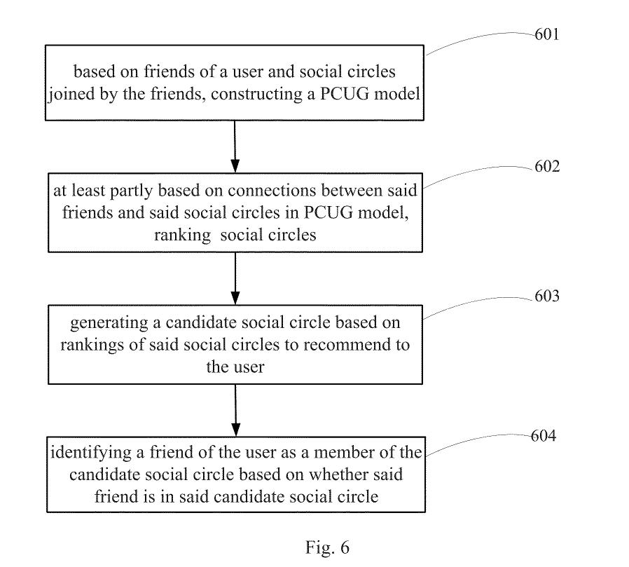

With reference to FIG. 5 now, FIG. 5 is a process flow diagram for a method of merging social circles based on similarity of their names according to an example of the present disclosure. At block 501, names of social circles are processed by applying word stemming to them. At block 502, social circles in the PCUG model are clustered based on a distance between the stemmed names of the social circles. Then at block 503, social circles in a cluster are merged as one social circle. According to an example, the distance between the stemmed names of the social circles can be an edit distance and this edit distance can also be normalized. For example, the distance can be defined as:

$$Distance ( {N}_{{c}_{i}} , {N}_{{c}_{j}} ) = \frac{{D}_{e} ( {N}_{{c}_{i}} , {N}_{{c}_{j}} )}{max ( len ( {N}_{{c}_{i}} ) , len ( {N}_{{c}_{i}} , {N}_{{c}_{j}} ) )} \qquad ( 4 )$$

Where Dₑ is the edit distance between social circle names cᵢ and cⱼ. The above formula (4) takes the length of the names into consideration. For example, the edit distance between “entertainment” and “entertainments” is 1. Likewise, the edit distance between “as” and “a” is also 1. However, “entertainment” and “entertainments” are much more similar than “as” and “a”.

Name de-duplication of social circles can improve the structure of the PCUG model. However, there are still single-user nodes without edges and social circle nodes which have only one edge. These two kinds of nodes can be removed from the PCUG model since user nodes without edges are considered noise in the model and it may not be useful to create a social circle containing only one member.

As described above, in an example, social circles can be merged if they have similar names. It is possible that a user is added in more than one social circle within a particular merged social circle set. For example, a music fan might be added to many music related circles created by his/her friends. After merging, all the music related social circles with similar names are merged into one single circle. In this case, this user has only one edge connected to the merged music circle node even though he was connected to many different music related circles. In order to distinguish this kind of relationship, according to an example, a weight can be assigned to a connection (i.e. edge) between each merged social circle and its member, wherein the weight is a function of the number of constituent social circles containing said member in the merged social circle. For example, the weight of each edge can be calculated as follows:

$${W}_{e} ( u , c ) = {\sum }_{{c}^{0} ∈ {C}_{u}^{0}} circle ( u , {c}^{0} ) \qquad ( 5 )$$

Where cᵤ⁰ is the original social circle set that has been merged to circle c.

Given a set of candidate social circles generated by the method described above, it is discovered that many candidate social circles share common members. This might be due to at least two reasons: the fact that a user can be put into multiple social circles, and the clustering and merging of similar social circles. In order to reduce overlap between social circles recommended to the user, according to an example of the present disclosure, ranking of the social circles may be further based on similarity between them. For example, a Maximum marginal relevance algorithm can be used to rank and select the candidate social circles by taking into account the diversity of social circle members. According to an example, the following formula may be used:

$${R}_{{c}_{i}} = {arg max}_{{c}_{i} ∈ S} [ λ r ( {c}_{i} ) - ( 1 - λ ) {max}_{{c}_{j} ∈ C - S} {Sim}_{mem} ( {c}_{i} , {c}_{j} ) ] \qquad ( 6 )$$

In this formula, C is the set of candidate social circles, S is the subset of C which has not been selected as a candidate, r(cᵢ) is the ranking score of cᵢ in PCUG model, and Sim( ) is a function to compute the member similarity of two circles. In an example, the similarity between two social circles is defined as percentage of the same members between these two social circles. λ is a parameter in the range of e.g. 0-1 to balance the ranking result and its diversity and can be set as needed. In an example, the first candidate social circle generated from the PCUG model can be selected as the first discovered social circle (i.e. cᵢ∈C-S), then formula (6) can be used to compute the rankings of the rest of the candidate social circles and rank them accordingly. After that, top-k candidates are selected as the candidate social circles.

With reference to FIG. 6 now, FIG. 6 is a process flow diagram for another method of generating a social circle for a user of a social network according to another example of the present disclosure. As shown, the method in FIG. 6 is almost the same as the method in FIG. 3, except that FIG. 6 further includes a block 604. Blocks 601-603 are the same as blocks 301-303 and will not be described in detail herein. At block 604, after a candidate social circle is generated, a friend of the user can be identified as a member of the candidate social circle based on whether said friend is in said candidate social circle.

As described above, in the PCUG model, if a user has an edge connecting to a candidate social circle, the user will be selected as a member of that social circle, no matter whether the user is really related to the circle or not. Actually, it is quite possible that a user is put into a social circle that she might not be related to. For example, a user may be put into a social circle named “football” by someone the user happened to play football with once. In such cases, the user may not be related to these circles or may even be irrelevant to them. This situation can be addressed by detecting and removing irrelevant users.

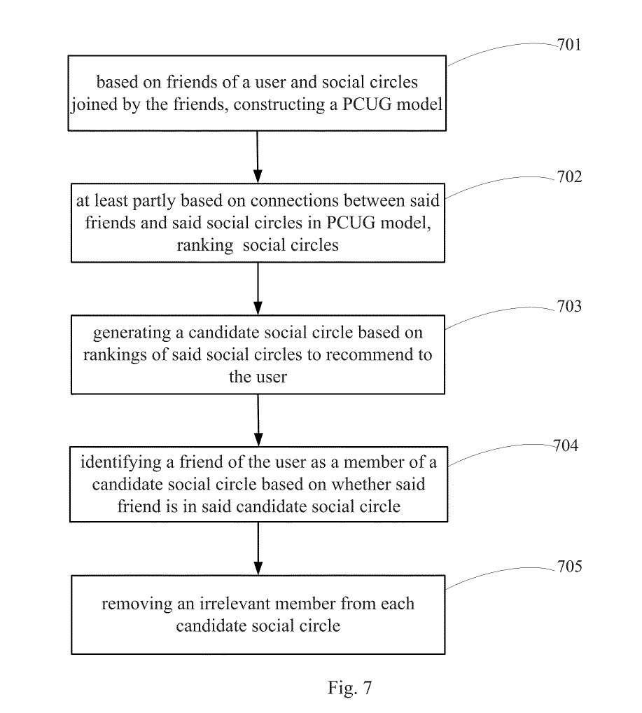

FIG. 7 illustrates a process flow diagram for another method of generating a social circle for a user of a social network according to another example of the present disclosure. The method of FIG. 7 takes into account the above described cases of possible irrelevant users. As shown, the method in FIG. 7 is almost the same as method in FIG. 6, except that FIG. 7 further includes a block 705. Blocks 701-704 are the same as blocks 601-604 and will not be described in detail herein. At block 705, after identifying members for each candidate social circle, an irrelevant member can be removed from the candidate social circle. In an example, removing an irrelevant member from each candidate social circle can be based on at least one of a weight of a connection between said member and said candidate social circle, member co-occurrence, and similarity between content posted by said member and said candidate social circle.

For example, a sampling approach can be used to select representative content for a social circle, and then similarity between this content and content posted by a member can be calculated. If the similarity is below a certain threshold, then the user can be considered as irrelevant and removed from the candidate social circle. In addition, the weight assigned to each edge or connection between a user node and a social circle node can be used to remove irrelevant users. For example, members of a candidate social circle can be ranked according to their weights and users with low rankings may be removed.

Instead of exploring the direct relationship between a social circle and its members, another approach can utilize the co-occurrence relationship between members of a circle to remove irrelevant members. The co-occurrence of two members can be calculated as the number of times they are put into the same social circles, as the following formula shows:

$$co ( {u}_{i} , {u}_{j} ) = {\sum }_{{c}^{0} ∈ {C}_{u}^{0}} circle ( {u}_{i} , {c}^{0} ) \times circle ( {u}_{j} , {c}^{0} ) \qquad ( 7 )$$

Wherein cᵤ⁰ is the original social circle set. A member of a social circle is ranked according to the total number of times (i.e. ranking score) this member co-occurs with all other members, as shown below:

$${R}_{{u}_{i} , c} = {\sum }_{{u}_{i} , {u}_{j} ∈ c {u}_{i} \neq {u}_{j}} co ( {u}_{i} , {u}_{j} ) \qquad ( 8 )$$

A member is removed if its ranking score is below a certain threshold. This threshold can be a fixed at a certain number, such as one, or can be automatically selected using a method, such as the Otsu thresholding method.

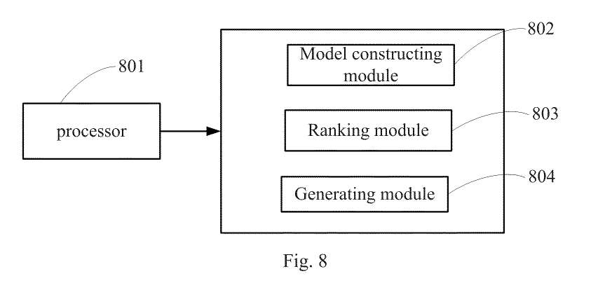

With reference to FIG. 8 now, FIG. 8 is a block diagram showing a non-transitory, computer-readable medium that stores code for generating a social circle for a user of a social network according to an example of the present disclosure. The non-transitory, computer-readable medium is generally referred to by the reference number 800.

The non-transitory, computer-readable medium 800 may correspond to any typical storage device that stores computer-implemented instructions, such as programming code or the like. For example, the non-transitory, computer-readable medium 800 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 801 generally retrieves and executes the computer-implemented instructions stored in the non-transitory, computer-readable medium 800 for detecting valuable sections on a web page. At block 802, a model constructing module may construct a personalized circle-user graph (PCUG) model based on friends of a user and social circles joined by the friends. At block 803, a ranking module may rank the social circles at least partly based on connections between friends and social circles in said PCUG model. At block 804, a generating module may generate a candidate social circle based on rankings of said social circles. The candidate social circle can be recommended to the user.

From the above depiction of the implementation mode, the above examples can be implemented by hardware, software or firmware or a combination thereof. For example the various methods, processes, modules and functional units described herein may be implemented by a processor (the term processor is to be interpreted broadly to include a CPU, processing unit, ASIC, logic unit, or programmable gate array etc.) The processes, methods and functional units may all be performed by a single processor or split between several processers. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

1. A method for generating a social circle for a user of a social network, comprising:
constructing, by executing a module stored on a non-transitory computer-readable storage medium, a personalized circle-user graph (PCUG) model based on friends of the user and social circles joined by the friends;
ranking the social circles at least partly based on connections between the friends and the social circles in the PCUG model; and
generating a candidate social circle based on rankings of the social circles.

2. The method of claim 1, wherein before constructing the PCUG model, the method further comprises:
merging social circles according to similarity of names of the social circles.

3. The method of claim 2, wherein merging social circles according to similarity of names of the social circles comprises:
processing names of social circles by applying word stemming to the names;
clustering social circles based on a distance between the stemmed names of the social circles; and
merging social circles in a cluster into a single social circle.

4. The method of claim 3, further comprising:
for each member of a merged social circle, assigning a weight to a connection between the merged social circle and the member, wherein the weight is a function of the number of constituent social circles containing the member in the merged social circle.

5. The method of claim 1, further comprising:
identifying a friend of the user as a member of the candidate social circle if the friend is in the candidate social circle.

6. The method of claim 5, wherein after the identifying, the method further comprises removing an irrelevant member from the candidate social circle.

7. The method of claim 6, wherein a member may be considered irrelevant based on at least one of a weight of a connection between the member and the candidate social circle, member co-occurrence, and similarity between content posted by the member and other members of the candidate social circle.

8. The method of claim 1, wherein the ranking is further based on similarity between social circles so as to reduce overlap between social circles.

9. A system for generating a social circle for a user of a social network, the system comprising:
a processor to execute stored instructions; and
a memory device to store instructions, the memory device comprising processor-executable code, that when executed by the processor, is adapted to:
based on friends of the user and social circles joined by the friends, construct a personalized circle-user graph (PCUG) model;
rank the social circles at least partly based on connections between the friends and the social circles in the PCUG model and similarity between the social circles; and
generate a candidate social circle based on rankings of the social circles.

10. The system of claim 9, wherein the memory stores processor-executable code adapted to merge social circles according to similarity of names of the social circles before constructing the PCUG model.

11. The system of claim 10, wherein the memory stores processor-executable code adapted to merge social circles according to similarity of names of the social circles by:
processing names of social circles by applying word stemming to the names;
clustering social circles based on a distance between the stemmed names of the social circles; and
merging social circles in a cluster into a single social circle.

12. The system of claim 11, wherein the memory further stores processor-executable code adapted to, for each member of a merged social circle, assign a weight to a connection between the merged social circle and the member, wherein the weight is a function of the number of constituent social circles containing the member in the merged social circle.

13. The system of claim 9, wherein the memory stores processor-executable code adapted to identify a friend of the user as a member of the candidate social circle based on whether the friend is in the candidate social circle.

14. The system of claim 13, wherein the memory stores processor-executable code adapted to remove an irrelevant member from the candidate social circle.

15. A non-transitory, computer-readable medium comprising code configured to direct a processor to:
merge social circles joined by friends of the user according to similarity of names of the social circles;
construct a personalized circle-user graph (PCUG) model based on the friends of the user and the social circles joined by the friends;
rank the social circles at least partly based on connections between the friends and the social circles in the PCUG model; and
generate a candidate social circle based on rankings of the social circles.
